(19) United States
(12) Patent Application Publication
(10) Pub. No.: US 2014/0227010 A1
(43) Pub. Date: Aug. 14, 2014

(54) Developer Supply Device

(71) Applicant: Brother Kogyo Kabushiki Kaisha, Nagoya-shi (JP)

(72) Inventors: Keisuke Takahashi, Nagoya-shi (JP); Kazuna Taguchi, Nagoya-shi (JP)

(73) Assignee: Brother Kogyo Kabushiki Kaisha, Nagoya-shi (JP)

(21) Appl. No.: 14/257,084

(22) Filed: Apr. 21, 2014

Related U.S. Application Data
(63) Continuation-in-part of application No. PCT/JP2012/074165, filed on Sep. 21, 2012.

(30) Foreign Application Priority Data
Oct. 21, 2011 (JP) 2011-231548

(51) Int. Cl. G03G 15/08

(52) U.S. Cl. CPC G03G 15/0805
USPC 399/284

(57) ABSTRACT

A developer can be appropriately carried by a brush roller in a developer supply device in which the brush roller is used as a developer carrying member. A developer carrying amount regulating member is positioned such that a tip portion of the developer carrying amount regulating member that is positioned close to a developer carrying member is inserted into a brush layer. The tip portion includes a surface positioned at an upstream side in a moving direction of the brush layer. The surface faces fibrous members that move to the developer carrying amount regulating member in the moving direction. The surface is configured to be inclined in the same direction as the moving direction.

### CROSS REFERENCE TO RELATED APPLICATION

This application claims priorities from Japanese Patent Application No. 2011-231548 filed Oct. 21, 2011. This application is also a continuation-in-part of International Application No. PCT/JP2012/074165 filed Sep. 21, 2012 in Japan Patent Office as a Receiving Office. The contents of this application are incorporated herein by reference.

### TECHNICAL FIELD

The present invention relates to a developer supply device configured to supply a powdery developer (dry developer) to a supply target.

### BACKGROUND

A device provided with a so-called “brush roller” that is used as a developer carrying member (developing roller) is well-known.

In the above-described conventional device, it is difficult to let the brush roller carry the developer appropriately. More specifically, for example, once the developer is carried by the brush roller and then captured between bristles of the brush of the brush roller, a blade cannot easily scrape the developer off. When the developer remains in the brush roller, the electric charge amount is likely to decrease because the developer is unlikely to be frictionally charged. If the developer continues to be carried by the brush roller, a white fog is generated over a formed image. Therefore, the structure in which the brush roller is used as a developer carrying member has not been commercially practical.

### SUMMARY

The present invention has been made to overcome the above problems. The object of the invention is to provide a developer supply device having a brush roller as a developer carrying member which is capable of appropriately carrying a developer thereon.

The present invention provides a developer supply device configured to supply a powdery developer to a supply target. The developer supply device includes a developer accommodation section, a developer carrying member, and a developer carrying amount regulating member.

The developer accommodation section accommodates the developer therein. The developer carrying member includes a roller body and a brush layer. The roller body has a cylindrical shape with an outer peripheral surface. The roller body is configured to be rotatable. The brush layer has a plurality of flexible fibrous members provided on the outer peripheral surface. The brush layer is configured to carry the developer supplied from the developer accommodation section. The developer carrying amount regulating member is configured to contact with the brush layer at a position which is upstream of a region where the brush layer faces the supply target in a moving direction of the fibrous members by rotation of the developer carrying member. Further, the position is downstream of a region where the developer is supplied from the developer accommodating section to the brush layer in the moving direction to thus regulate an amount of the developer carried by the brush layer.

The developer carrying amount regulating member includes a tip portion positioned at the developer carrying member and configured to be inserted in the brush layer. The tip portion has a surface positioned at an upstream side in the moving direction. The surface faces the fibrous members that move in the moving direction to the developer carrying amount regulating member. The surface is configured to be inclined in a direction the same as the moving direction.

The developer carrying member is configured to contact with the supply target and to allow the supply target to be inserted into the brush layer. The developer carrying amount regulating member is positioned such that an insertion amount of the developer carrying amount regulating member into the brush layer is greater than an insertion amount of the supply target into the brush layer. Both of the above insertion amount means a length of the depth of the brush layer, i.e., a radial length of the developer carrying member.

In the developer supply device having the above configuration, the tip portion of the developer carrying amount regulating member contacts with the brush layer. Therefore, developer carried by the brush layer (especially developer between adjacent fibrous members) can be appropriately scraped off, thereby appropriately preventing the developer from being captured in the brush layer for a long time. Accordingly, a white fog on formed image can be prevented. Thus, the present invention can provide a structure capable of appropriately carrying a developer on the developer carrying member as a brush roller.

### BRIEF DESCRIPTION OF THE DRAWINGS

The particular features and advantages of the invention as well as other objects will become apparent from the following description taken in connection with the accompanying drawings, in which:

FIG. 1 is a schematic configuration diagram of a laser printer as an image formation device according to the present invention;

FIG. 2A is an enlarged view of a tip portion of a regulating blade shown in FIG. 1;

FIG. 2B is an enlarged view of a tip portion of a regulating blade as a comparative example;

FIG. 3 is an enlarged view showing a modification of the regulating blade shown in FIG. 1; and

FIG. 4 is an enlarged view showing another modification of the regulating blade shown in FIG. 1.

### DETAILED DESCRIPTION

Hereinafter, an embodiment of the present invention will be described with reference to the accompanying drawings.

### Configuration of Laser Printer

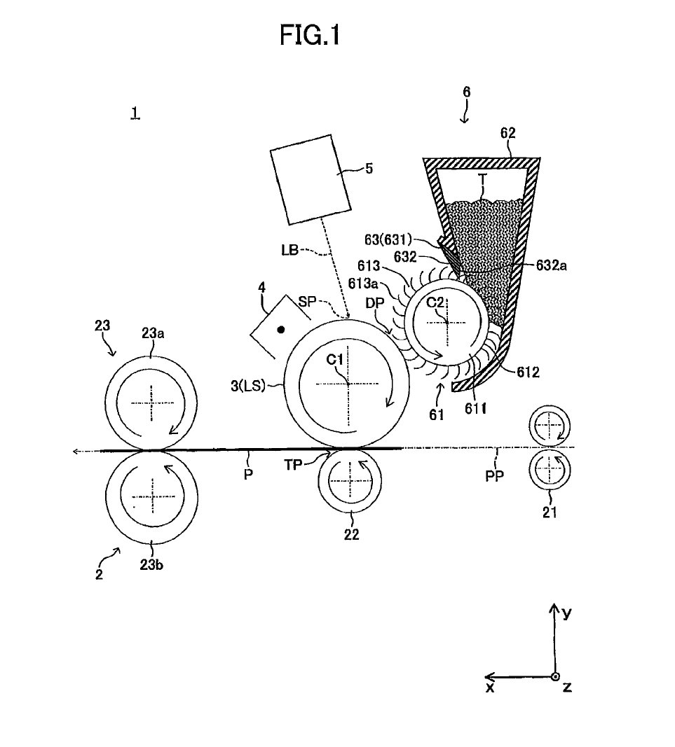

FIG. 1 is a schematic configuration diagram of a laser printer 1 as one example of an image formation device according to the present invention. As shown in FIG. 1, the laser printer 1 includes a paper conveyance mechanism 2, a photosensitive drum 3, a charging unit 4, a scanner unit 5, and a developing device 6. Sheets of paper P are stacked and accommodated in a paper feed tray (not shown) provided in the laser printer 1. The paper conveyance mechanism 2 is configured to convey a paper sheet P along a predetermined paper conveyance path PP.

An electrostatic latent image bearing surface LS is formed on a peripheral surface of the photosensitive drum 3 as one example of a supply target. The electrostatic latent image bearing surface LS is a cylindrical surface having an axis extending parallel to a main scanning direction (referred to as a z-axis direction in FIG. 1, a “paper width direction”, or a “width direction” of the laser printer 1). An electrostatic latent image generated by an electric potential distribution is formed on the electrostatic latent image bearing surface LS. And the electrostatic latent image bearing surface LS is configured to carry toner T as one example of a developer at the position corresponding to the electrostatic latent image. The photosensitive drum 3 is rotated about an axis C1 extending parallel to the main scanning direction in a direction (clockwise) indicated by arrow in FIG. 1. As a result, the electrostatic latent image bearing surface LS is configured to move (circle) in the sub-scanning direction perpendicular to the main scanning direction.

The charging unit 4 is located so as to face the electrostatic latent image bearing surface LS. The charging unit 4 is a corotron-type or scorotron-type charging unit. The charging unit 4 is configured to uniformly and positively charge the electrostatic latent image bearing surface LS.

The scanner unit 5 generates a laser beam LB having the predetermined wavelength band modulated based on image data (a process of turning ON/OFF the emission of light is controlled depending on whether or not a pixel exists). The scanner unit 5 is configured to focus an image on a scan position SP on the electrostatic latent image bearing surface LS, and move (scan) the focused position in the main scanning direction at a constant speed. In this embodiment, the scan position SP is provided downstream of the charging unit 4 and upstream of the developing device 6 in a moving direction of the electrostatic latent image bearing surface LS caused by rotation of the photosensitive drum 3.

The developing device 6 as one example of a developer supply device is disposed so as to face the electrostatic latent image bearing surface LS. The developing device 6 has a developing region DP which faces the electrostatic latent image bearing surface LS at a close distance. The developing device 6 is configured to supply the positively-charged toner T to the photosensitive drum 3 (the electrostatic latent image bearing surface LS) in the developing region DP. In this embodiment, the toner T is a black powdery dry developer that is positively charged and made from a non-magnetic one-component substance. The detailed configuration of the developing device 6 will be described later.

The specific configuration of each component of the laser printer 1 will be described in more detail.

The paper conveyance mechanism 2 includes a pair of registration rollers 21, a transfer roller 22, and a fixing unit 23. The registration rollers 21 are configured to send a paper sheet P at a predetermined timing to a transfer position TP between the photosensitive drum 3 and the transfer roller 22.

The transfer roller 22 is disposed so as to face the electrostatic latent image bearing surface LS across the paper conveyance path PP at the transfer position TP. The transfer roller 22 is configured to be rotated in a direction (counterclockwise) indicated by arrow in FIG. 1. The transfer roller 22 is electrically connected to a transfer bias power supply circuit (not shown). A predetermined transfer bias is applied to the transfer roller 22 in order to transfer the toner T on the electrostatic latent image bearing surface LS to a paper sheet P.

The fixing unit 23 includes a heating roller 23a and a pressure roller 23b. The heating roller 23a is made from a rotation body that is placed parallel to the paper width direction. The heating roller 23a is configured to heat the toner T on a paper sheet P, thereby fixing a toner image on the paper sheet P. The pressure roller 23b is placed parallel to the heating roller 23a so as to face the heating roller 23a across the paper conveyance path PP. The pressure roller 23b is made from a rotation body having a peripheral silicon rubber layer. The pressure roller 23b is pressed against the heating roller 23a by a predetermined pressure.

### Developing Device

The developing device 6 includes a developing roller 61, a toner case 62, and a regulating blade 63. The toner case 62 as one example of a developer storage section is made from a box-like member configured to store the toner T therein. The developing roller 61 consists of a so-called well-known “brush roller” which is similar to those used in Japanese Patent Application Publication Nos. S57-64266, S57-108870, and S58-57156. The developing roller 61 is supported by the toner case 62 in a manner to be rotatable about an axis C2 extending parallel to the main scanning direction in a direction (counterclockwise) indicated by arrow in FIG. 1.

More specifically, the developing roller 61 includes a roller body 611 as a cylindrical member, and a brush layer 613 provided on a roller outer peripheral surface 612 that is an outer peripheral surface of the roller body 611. The developing roller 61 as one example of a developer carrying member is configured to carry the toner T on the brush layer 613 having a plurality of flexible fibrous members 613a planted on the roller outer peripheral surface 612. The brush layer 613 faces the photosensitive drum 3 in the developing region DP.

The regulating blade 63 as one example of a developer carrying amount regulating member includes a blade body 631 and a tip portion 632. The blade body 631 is fixed to the toner case 62. The tip portion 632 is provided in one end of the regulating blade 63 that is closer to the developing roller 61, and protrudes to the developing roller 61. The regulating blade 63 is configured to have higher rigidity than a single fibrous member 613a, which means that the regulating blade 63 is not flexible than the single fibrous member 613a. More specifically, in the present embodiment, the regulating blade 63 is made from a metal plate such as stainless steel, and is formed integrally.

The regulating blade 63 is configured to scrape off some of the toner T carried by the brush layer 613 and then regulate the amount of toner T carried by the brush layer 613. More specifically, the regulating blade 63 is configured to be contact with the brush layer 613 upstream of the developing region DP and downstream of the region where the toner T in the toner case 62 is supplied to the brush layer 613, in a moving direction of the brush layer 613 by rotation of the developing roller 61. The region where the space in the toner case 62 faces the developing roller 61 is referred to as a carrying region. The carrying region is positioned on the opposite side of the axis C2 from the developing region DP.

The regulating blade 63 is placed in a manner to insert the tip portion 632 into the brush layer 613. More specifically, the regulating blade 63 is provided in a manner that the tip of the tip portion 632 reaches a lower end of the brush layer 613. In other words, the tip portion 632 of the regulating blade 63 is located adjacent to the roller outer peripheral surface 612. Moreover, the regulating blade 63 is disposed in a manner that an insertion amount (blade insertion amount) of the tip portion 632 of the regulating blade 63 into the brush layer 613 is greater than an insertion amount (developing nip amount) of the photosensitive drum 3 into the brush layer 613. It is noted that the “blade insertion amount” and the “developing nip amount” are defined as a length in a depth direction of the brush layer 613 or a radial direction of the developing roller 61.

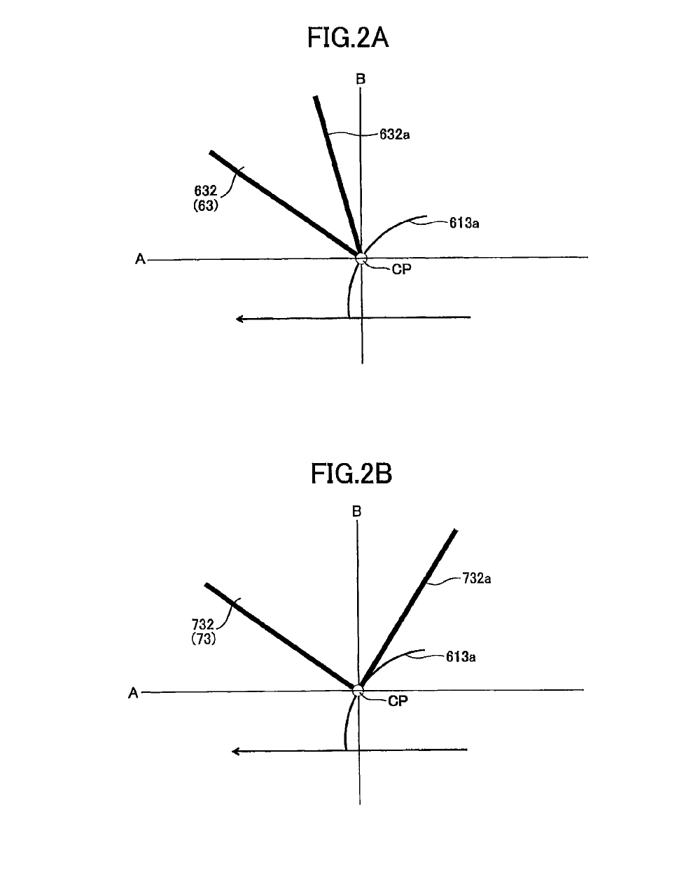

FIG. 2A is an enlarged view of the tip portion 632 of the regulating blade 63 according to the present embodiment. FIG. 2B is an enlarged view of a tip portion 732 of a regulating blade 73 as a comparative example.

Referring to FIGS. 1 and 2A, in the present embodiment, the regulating blade 63 is provided in a manner that a brush facing surface 632a as a surface of the tip portion 632 is inclined in the same direction as a moving direction of the fibrous members 613a by rotation of the developing roller 61 about the axis C2 (See the arrow in FIG. 2). In other words, the brush facing surface 632a is inclined so as to be positioned downstream of the tip portion of the regulating blade 63 in the moving direction. In this embodiment, the brush facing surface 632a is a surface corresponding to the upstream portion in the tip portion 632 in the moving direction (See arrow in FIG. 2). The brush facing surface 632a is configured to face the fibrous members 613a that are moving to the tip portion 632 in the moving direction.

More specific description will be made referring to FIG. 2A. Suppose that a point where the tip of the regulating blade 63 is in contact with the fibrous members 613a is referred to as CP; a straight line extending parallel to the moving direction of the fibrous members 613a at the point CP is referred to as a line A; and a straight line extending perpendicularly to both of the line A and the main scanning direction through the point CP (or a straight line extending parallel to the radial direction of the developing roller 61 through the point CP) is referred to as line B. The brush facing surface 632a of the tip portion 632 is positioned downstream of the line B in the moving direction of the fibrous members 613a.

### Operation and Effects

The following description will be made for explaining a summary of the operation of the above-described embodiment as well as the effects and advantages thereof, referring to the drawings.

Referring to FIG. 1, when the developing roller 61 rotates about the axis C2, the toner T accommodated in the toner case 62 is supplied to the brush layer 613 in the carrying region. As a result, the toner T is carried by the brush layer 613, and sent to the developing region DP from the carrying region.

The brush layer 613 carrying the toner T contacts with the regulating blade 63 at a position between the carrying region and the developing region DP, when the developing roller 61 rotates about the axis C2. At this position, as the tip portion 632 of the regulating blade 63 is inserted in the brush layer 613, the toner T carried by the brush layer 613 is partially removed. In this manner, the amount of toner T carried by the brush layer 613 is regulated.

In this case, as described above, the regulating blade 63 has higher rigidity than the fibrous member 613a. Moreover, the regulating blade 63 is in contact with the brush layer 613 in a manner that the blade insertion amount is greater than the developing nip amount, and that the brush facing surface 632a of the tip portion 632 is placed downstream of the line B in the moving direction of the fibrous members 613a, as shown in FIG. 2A.

In the above configuration, some toner T are pushed up on the brush facing surface 632a. Therefore, the toner T held by the brush layer 613 (especially toner between the adjacent fibrous members 613a) can be appropriately scraped off. Moreover, the toner T held by the brush layer 613 (especially toner between the adjacent fibrous members 613a) is frictionally charged appropriately, thereby properly preventing the toner T, which can cause a white fog, from being stuck in the brush layer 613 for a long time. Therefore, the configuration of the present embodiment enables the developing roller 61 as one example of a brush roller to appropriately carry the toner T.

On the other hand, as shown in FIG. 2B, when the regulating blade 73 is in contact with the brush layer 613 in a manner that the brush facing surface 732a of the tip portion 732 is placed upstream of line B in the moving direction of the fibrous members 613a, a majority of the toner T carried by the brush layer 613 (especially toner between the adjacent fibrous members 613a) passes through “below” the tip portion 732 of the regulating blade 73. Moreover, in this case, the toner T carried by the brush layer 613 is pressed against the developing roller 61 (the roller body 611; see FIG. 1). In this case, the toner T is stuck around the base of the fibrous members 613a (or the lower end portion of the brush layer 613), promoting the generation of a white fog over a formed image.

When the toner T is carried by the brush layer 613 in the carrying region, or contacts with the regulating blade 63, the toner T is frictionally charged. After the toner T passes through the regulating blade 63 and is properly charged while being carried appropriately by the developing roller 61 (i.e. being carried uniformly so as to prevent the clogging of the toner between the fibrous members), the toner T is supplied to the photosensitive drum 3 (the electrostatic latent image bearing surface LS) in the developing region DP by the rotation of the developing roller 61 about the axis C2. Accordingly, an appropriate toner image is formed on the electrostatic latent image bearing surface LS to properly prevent possible generation of a white fog, thereby forming an appropriate image on a paper sheet R.

### Modified Examples

It should be noted that the above embodiment is merely illustrated as an exemplary embodiment of the present invention that the applicant tentatively considers the best mode at the time of filing the application. Therefore, the present invention is not limited to the above embodiment. Accordingly, various modifications may be made to the above embodiment without deviating from the scope of the present invention.

The present invention is not only applied to a single-color laser printer, but also applied to so-called electrophotographic-type image formation devices such as one example of a color laser printer and single-color and color copiers. In this case, the shape of a photosensitive member may be a flat plate, an endless belt, or the like, for example, instead of a drum shape as in the above embodiment.

Any light sources (such as LEDs, EL (electroluminescence) elements, and fluorescent materials) may be used as the exposure light source instead of the laser scanner. In this case, the “main scanning direction” may be parallel to a direction in which light-emitting elements (LEDs or the like) are arranged.

Alternatively, the present invention may be applied to image formation devices of any type other than the above electrophotographic type (e.g., a toner jet type without a photosensitive member, an ion flow type, a multi-stylus electrode type, and the like). In this case, image formation media such as paper sheets P, and aperture electrodes (See U.S. Pat. No. 5,293,181 and the like, for example) are equivalent to the supply target of the present invention.

The material of the regulating blade 63 is not limited to metal. For example, the regulating blade 63 may be made from synthetic resin. In this case, the regulating blade 63 may be made from a conductive synthetic resin or a semiconductor-type synthetic resin in order to suppress the charge-up.

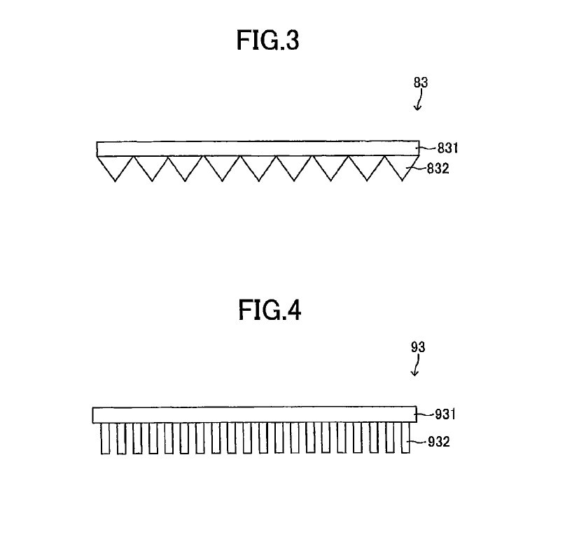

FIGS. 3 and 4 are enlarged views showing modified examples of the regulating blade 63 shown in FIG. 1. As shown in FIGS. 3 and 4, regulating blades 83 or 93 may be a serrated or comb-like member having a plurality of protruding tip portions 832 or 932 arranged in the direction of axis C2 of the developing roller 61.

In this case, as shown in FIG. 3, the tip portions 832 may be projections of an inverted V shape or an inverted U shape. Alternatively, as shown in FIG. 4, the tip portions 932 may be rod-like projections. The tips (or lower ends) of the protruding tip portions 832 or 932 shown in FIGS. 3 and 4 may be rounded off. Furthermore, a plurality of protruding tip portions 832 and 932 may be arranged at regular intervals along the axis C2 of the developing roller 61.

In the above configuration, the protruding tip portion 832 or 932 of the regulating blade 83 or 93 that is a serrated or comb-like member is inserted into the brush layer 613. Therefore, some toner T carried by the brush layer 613 (especially toner between the adjacent fibrous members 613a) can be appropriately scraped off, thereby preventing the clogging of toner in the brush layer 613 (especially around the lower end portion or the base). Moreover, since the regulating blade 63 is a comb-like or serrated member, the rotation torque of the developing roller 61 becomes smaller. Therefore, the toner T is appropriately carried by the developing roller 61 as one example of a brush roller.

Other modified examples that have not been particularly mentioned are also within the technical scope of the present invention without deviating from the scope of claims.

Among the elements constituting means for solving the problems of the present invention, the elements that have been described operatively or functionally include not only the specific structures disclosed in the above embodiments, but also any structure capable of realizing the above operation and functions. Furthermore, the contents of each application publication cited herein (including specifications and drawings) can be incorporated as part of this specification.

### EXPLANATION OF NUMERALS

1 laser printer
2 paper conveyance mechanism
3 photosensitive drum (supply target)
4 charging unit
5 scanner unit
6 developing device (developer supply device)
61 developing roller (developer carrying member)
611 roller body
612 roller outer peripheral surface
613 brush layer
613a fibrous member
62 toner case
63 regulating blade
631 blade body
632 tip portion
632a brush facing surface
C2 axis
DP developing region
LS electrostatic latent image bearing surface
T toner (developer)

What is claimed is:

1. A developer supply device configured to supply a powdery developer to a supply target, comprising:
a developer accommodation section for accommodating the developer therein;
a developer carrying member comprising a roller body and a brush layer, the roller body having a cylindrical shape with an outer peripheral surface, the roller body being configured to be rotatable, the brush layer having a plurality of flexible fibrous members planted on the outer peripheral surface, and the brush layer being configured to carry the developer supplied from the developer accommodation section; and
a developer carrying amount regulating member configured to contact with the brush layer at a position which is upstream of a region where the brush layer faces the supply target in a moving direction of the fibrous members by rotation of the developer carrying member, the position being downstream of a region where the developer is supplied from the developer accommodating section to the brush layer in the moving direction to thus regulate an amount of the developer carried by the brush layer, wherein
the developer carrying amount regulating member comprises a tip portion positioned at the developer carrying member and configured to be inserted in the brush layer, and the tip portion having a surface positioned at an upstream side in the moving direction, and
the surface faces the fibrous members that move in the moving direction to the developer carrying amount regulating member, and the surface is configured to be inclined in a direction the same as the moving direction.

2. The developer supply device according to claim 1, wherein the developer carrying member is configured to contact with the supply target and to allow the supply target to be inserted into the brush layer; and
the developer carrying amount regulating member is positioned such that an insertion amount of the developer carrying amount regulating member into the brush layer is greater than an insertion amount of the supply target into the brush layer.

3. The developer supply device according to claim 1, wherein the developer carrying amount regulating member is made from a metal plate.

4. The developer supply device according to claim 1, wherein the developer carrying amount regulating member is made from stainless steel.
